(19) United States
(12) Patent Application Publication
(10) Pub. No.: US 2008/0235750 A1
(43) Pub. Date: Sep. 25, 2008

(54) BAND SWITCHABLE AMPLIFIER SYSTEM

(75) Inventors: Tibor Urbanek, Britton, MI (US); Dean Arvantis, Crystal Lake, IL (US); Greg Dalton, Grayslake, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: EMERSON NETWORK POWER CONNECTIVITY SOLUTIONS, Bannockburn, IL (US)

(21) Appl. No.: 12/051,704

(22) Filed: Mar. 19, 2008

Related U.S. Application Data
(60) Provisional application No. 60/895,528, filed on Mar. 19, 2007.

(51) Int. Cl. H04N 7/173

(52) U.S. Cl. 725/127

(57) ABSTRACT

An amplifier systems for a cable television (CATV) system to increase the ability of a sub-band to transmit information using switchable bands.

### CROSS-REFERENCE TO RELATED APPLICATIONS

This application claims priority of U.S. Provisional Patent Application No. 60/895,528, filed Mar. 19, 2007, in the United States Patent and Trademark Office, the disclosure of which is incorporated herein by reference in its entirety.

### BACKGROUND OF THE INVENTION

1. Field of the Invention

The present general inventive concept relates generally to amplifier systems used, for example, with a cable television (CATV) system to increase the ability of a sub-band to transmit information.

2. Description of the Related Art

In CATV distribution systems, amplifiers are used to amplify the level of the signal. Today, most cable television systems deliver more than just TV channels, these systems also deliver other services such as internet, telephone, video on demand, etc. For this reason, a CATV system does not just deliver signals to consumers but also receives signals from the consumers, such as, for example when a consumer is surfing the Internet or ordering a movie from the cable company using the cable box. For these reasons, a CATV system is divided into two sub-bands. One sub-band is used for sending signals to consumers, also called a downstream band. Another sub-band is used for the signals sent back by the consumer back, also called an upstream band. Amplifiers used in these systems are designed to pass signals in both directions at the specified frequencies.

In typical North American systems, the downstream band ranges in frequency from 52-1000 MHz, and the upstream band ranges from 5-42 MHz. Referring to FIG. 1 of the prior art, a diplex filter allows the system to make use of one set of frequencies for the downstream band and another set of frequencies (between 5 and 42 MHz) for the upstream band. As the market for additional services increases, there is a demand for increased bandwidth in CATV systems for both downstream and upstream bands. CATV systems may change the sub-band frequency division to allow wider upstream band and may also increase downstream band above 1000 MHz. However, there is a need for an increase of the current CATV system's ability to transfer information from the cable company to the user. Therefore, it would be beneficial to provide a system that allows for an increase in the capacity of transmitting information.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. A more complete appreciation of the invention and many of the advantages thereof will be readily obtained as the same becomes better understood by references to the detailed description when considered in connection with the accompanying drawings, wherein:

FIG. 1 is a schematic of a conventional amplifier system of prior art showing the use of diplex filters used in a traditional cable TV system.

FIG. 2 is a schematic of a system illustrating an exemplary embodiment of the present system showing a sub-band with multiple switching devices for amplifying the amount of transmitted information.

FIG. 3 is a schematic of is a schematic of an amplifier system of the present general inventive concept showing the use of two sub-bands each with multiple switching devices for amplifying the amount of transmitted information.

FIG. 4 is a schematic of an amplifier system of the present general inventive concept showing a sensor for sensing a special signal coming from the CATV operator's central office to the input of the amplifier system.

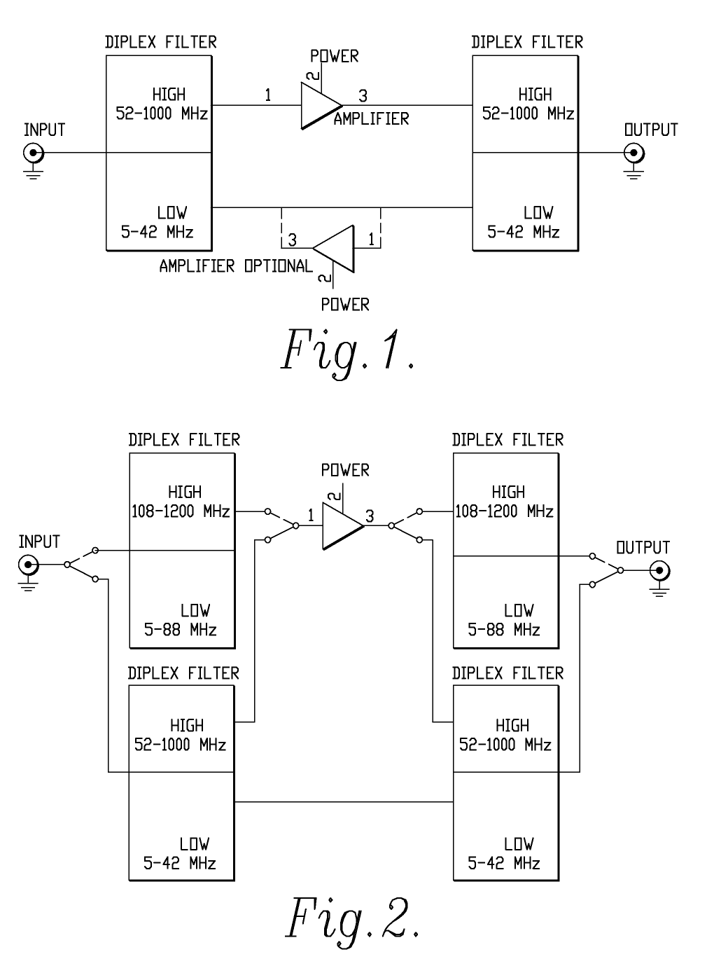

### SUMMARY OF THE INVENTION

A principal object of the present general inventive concept is to provide an amplifier system for use with a CATV system.

Another object of the invention is to provide a system that increases the capacity of transmitting information in a CATV system.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### DESCRIPTION OF THE PREFERRED EMBODIMENTS

As required, one or more detailed embodiments of the present general inventive concept are disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present general inventive concept in virtually any appropriately detailed structure.

There is a need for more bandwidth in CATV systems, in both downstream and upstream bands, due to additions of many new services such as, for example, high definition TV programming, video on demand, VoIP, digital video recorders, etc.

In one embodiment, a variety of available switching devices are added to the amplifier system. Additional diplex filters are added to the amplifier system. The amplifier then switches and/or selects between two different sub-bands, depending on a particular system. This also enables a CATV operator to upgrade its system from one sub-band division to another without the need of replacing the amplifier.

Referring to FIG. 2, an amplifier system, used in current CATV systems for North American frequency sub-bands and possible future sub-bands, has multiple switching devices to increase the capacity the downstream band to transmit information. This amplifier system has no amplification of the upstream band. In another embodiment, the upstream band has multiple switching devices to increase the capacity of the upstream band while the downstream band has no amplification.

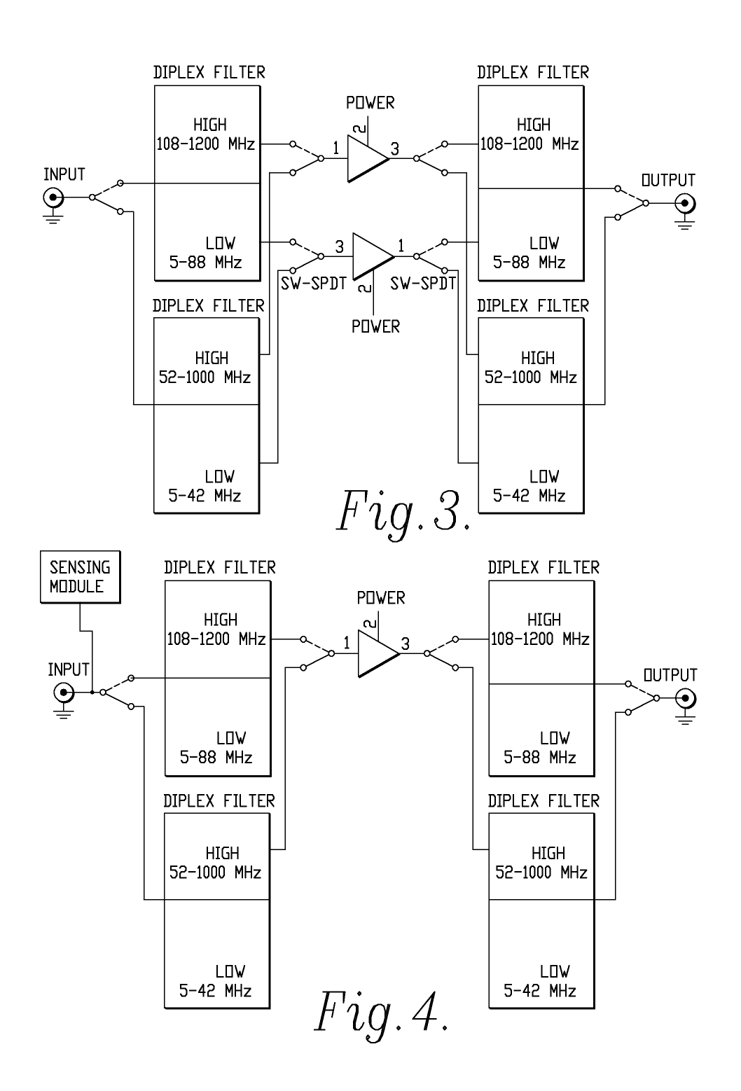

Referring to FIG. 3, the amplifier system has multiple switching devices for both the downstream band and the upstream band to increase the information sent and received by the CATV company and the consumer.

Referring to FIG. 4, a sensor may be installed in the amplifier system. The sensor can sense a special signal coming from the CATV operator's central office to the input of the amplifier system. The sensor can then switch all necessary switching devices and change the sub-band frequency divisions of the amplifier system.

Frequencies, types of switches, and number of switches are not limited as shown in the figures and described herein There are many possible frequencies and switching scenarios.

Although the foregoing detailed description of the present general inventive concept has been described by reference to an exemplary embodiment, and the best mode contemplated for carrying out the present general inventive concept has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present general inventive concept. Therefore, it is contemplated to cover the present general inventive concept and any and all changes, modifications, variations, or equivalents that fall with in the true spirit and scope of the underlying principles disclosed and claimed herein. Consequently, the scope of the present general inventive concept is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims. It is also to be understood that the following claims are intended to cover all of the generic and specific features of the invention herein described, and all statements of the scope of the invention which, as a matter of language, might be said to fall there between.

What is claimed is:

1. A cable television system having an amplification system, the cable television system comprising:
a first sub-band having multiple switching devices to amplify the first sub-band.

2. The cable television system according to claim 1, further comprising:
at least one diplex filter;
a second sub-band; and
a switch to select the first sub-band or the second sub-band.

3. A cable television signal amplification system, the amplification system comprising:
a downstream band to transmit information;
an upstream band to transmit information; and
multiple switching devices on one of the upstream band or the downstream band to increase a capacity of the upstream band or the downstream band.

4. The cable television signal amplification system of claim 3, wherein the other of the upstream band or the downstream band that does not have multiple switching devices has no amplification device.

5. A cable television signal amplification system, the amplification system comprising:
a upstream band to transmit information having multiple switching devices to increase a capacity of the upstream band; and
an downstream band to transmit information having multiple switching devices to increase a capacity of the downstream band.

6. The cable television signal amplification system according to claim 5, further comprising:
a sensor in the amplifier system to detect a control signal generated from a sender.

7. The cable television signal amplification system according to claim 6, wherein the sensor enables the system to change a sub-band frequency division of the amplification system.
